(19) United States
(12) Patent Application Publication
(10) Pub. No.: US 2024/0104472 A1
(43) Pub. Date: Mar. 28, 2024

(54) SYSTEMS AND METHODS FOR ASSESSING MERGERS AND ACQUISITION VULNERABILITIES IN FINANCIAL MARKETS

(71) Applicant: JPMORGAN CHASE BANK, N.A., New York, NY (US)

(72) Inventors: Andrea SOLDA, London (GB); Ashleigh Ann THOMPSON, New York, NY (US); Dhia E STAMBOULI, London (GB); Alfredo PORRETTI, New York, NY (US); Darren NOVAK, London (GB)

(21) Appl. No.: 17/935,353

(22) Filed: Sep. 26, 2022

(51) Int. Cl. G06Q 10/06

(52) U.S. Cl. CPC G06Q 10/0635

(57) ABSTRACT

Systems and methods for assessing mergers and acquisition vulnerabilities in financial markets are disclosed. Embodiments allow advising institutions, such as financial institutions, to recognize times when a hostile party might take advantage of a market climate or other adverse events and attempt a hostile takeover. Embodiments may monitor public markets and may quantify the vulnerability of any given company based on publicly available data to protect the interests of these companies before other parties can exploit these vulnerabilities.

### BACKGROUND OF THE INVENTION

### 1. Field of the Invention

Embodiments generally relate to systems and methods for assessing mergers and acquisition vulnerabilities in financial markets.

### 2. Description of the Related Art

Public corporations are owned by shareholders, which leaves open the possibility of hostile takeover attempts. Certain market climates and/or adverse events may give rise to conditions that make it more likely for such attempts to take place.

### SUMMARY OF THE INVENTION

Systems and methods for managing the assessment of mergers and acquisition vulnerabilities in financial markets are disclosed. In one embodiment, a method for assessing company vulnerabilities in financial markets may include: (1) receiving, by vulnerability assessment computer program, time series data for a plurality of companies; (2) aggregating, cleaning, and pre-processing, by the vulnerability assessment computer program, the time series data for each company; (3) generating, by the vulnerability assessment computer program, sector benchmark data for each company comprising a sector value benchmark, a sector momentum benchmark, and a sector volatility benchmark; (4) generating, by the vulnerability assessment computer program, company financial health time series data for each company comprising company share price performance, company financial metrics extracted from SEC filings, and/or per-share indicators; (5) identifying, by the vulnerability assessment computer program, an anomaly in the financial health time series data for one of the companies, wherein the anomaly is identified comparing a value, a momentum, and a volatility for each company to the sector value benchmark, the sector momentum benchmark, and the sector volatility benchmark, respectively; (6) identifying, by the vulnerability assessment computer program, a plurality of comparable companies to the one company; (7) predicting, by the vulnerability assessment computer program using a trained machine learning-based risk estimation engine, a probability of an adverse event for the one company based on a plurality of features; (8) generating, by the vulnerability assessment computer program, a partial risk score for the one company comprising the probability of the adverse event, quantitative indicators derived from the time series data benchmarking and anomaly detection, and a feature weighting for each of the plurality of features; (9) validating, by the vulnerability assessment computer program, the prediction; and (10) publishing, by the vulnerability assessment computer program, the prediction.

In one embodiment, the method may also include normalizing the time series data at an industry level.

In one embodiment, the benchmarks may be generated using dynamic factor models with principal component analysis.

In one embodiment, the time series data may include a learned weighted index capturing co-movements of its constituents.

In one embodiment, the sector benchmark time series data for each company comprises share price performance for each company and/or macro market indicators.

In one embodiment, the plurality of comparable companies to the one company may be identified using a North American Industry Classification System (NAICS) designation and public filings for the comparable companies.

In one embodiment, the plurality of features may include financial features, trading features shareholder composition features, and governance structure features.

According to another embodiment, a system may include a plurality of data sources comprising a markets data data source, a financial disclosure data source, a company metadata data source, a company statute and legal documents data source, and a shareholder filings data source and a vulnerability assessment computer program executed by an electronic device. The vulnerability assessment computer program may receive time series data for a plurality of companies from the plurality of data sources, may aggregate, clean, and pre-process the time series data for each company, may generate sector benchmark data for each company comprising a sector value benchmark, a sector momentum benchmark, and a sector volatility benchmark, may generate company financial health time series data for each company comprising company share price performance, company financial metrics extracted from SEC filings, and/or per-share indicators, may identify an anomaly in the financial health time series data for one of the companies, wherein the anomaly is identified comparing a value, a momentum, and a volatility for each company to the sector value benchmark, the sector momentum benchmark, and the sector volatility benchmark, respectively, may identify a plurality of comparable companies to the one company, may predict, using a trained machine learning-based risk estimation engine, a probability of an adverse event for the one company based on a plurality of features, may generate a partial risk score for the one company comprising the probability of the adverse event, quantitative indicators derived from the time series data benchmarking and anomaly detection, and a feature weighting for each of the plurality of features, may validate the prediction, and may publish the prediction.

In one embodiment, the vulnerability assessment computer program normalizes the time series data at an industry level.

In one embodiment, the benchmarks may be generated using dynamic factor models with principal component analysis.

In one embodiment, the time series data may include a learned weighted index capturing co-movements of its constituents.

In one embodiment, the sector benchmark time series data for each company may include share price performance for each company and/or macro market indicators.

In one embodiment, the plurality of comparable companies to the one company may be identified using a North American Industry Classification System (NAICS) designation and public filings for the comparable companies.

In one embodiment, the plurality of features may include financial features, trading features shareholder composition features, and governance structure features.

According to another embodiment, a non-transitory computer readable storage medium, including instructions stored thereon, which when read and executed by one or more computer processors, cause the one or more computer processors to perform steps comprising: receiving time series data for a plurality of companies; aggregating, cleaning, and pre-processing the time series data for each company; generating sector benchmark data for each company comprising a sector value benchmark, a sector momentum benchmark, and a sector volatility benchmark; generating company financial health time series data for each company comprising company share price performance, company financial metrics extracted from SEC filings, and/or per-share indicators; identifying an anomaly in the financial health time series data for one of the companies, wherein the anomaly is identified comparing a value, a momentum, and a volatility for each company to the sector value benchmark, the sector momentum benchmark, and the sector volatility benchmark, respectively; identifying a plurality of comparable companies to the one company; predicting, using a trained machine learning-based risk estimation engine, a probability of an adverse event for the one company based on a plurality of features; generating a partial risk score for the one company comprising the probability of the adverse event, quantitative indicators derived from the time series data benchmarking and anomaly detection, and a feature weighting for each of the plurality of features; validating the prediction; and publishing the prediction.

In one embodiment, the instructions may also cause the one or more computer processors to normalize the time series data at an industry level.

In one embodiment, the benchmarks may be generated using dynamic factor models with principal component analysis.

In one embodiment, the time series data may include a learned weighted index capturing co-movements of its constituents.

In one embodiment, the sector benchmark time series data for each company may include share price performance for each company and/or macro market indicators.

In one embodiment, the plurality of comparable companies to the one company may be identified using a North American Industry Classification System (NAICS) designation and public filings for the comparable companies.

In one embodiment, the plurality of features may include financial features, trading features shareholder composition features, and governance structure features.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for assessing mergers and acquisition vulnerabilities in financial markets according to an embodiment.

FIG. 2 depicts a method for assessing mergers and acquisition vulnerabilities in financial markets according to an embodiment.

FIG. 3 depicts an exemplary computing system for implementing aspects of the present disclosure.

### DETAILED DESCRIPTION OF PREFERRED EMBODIMENTS

Embodiments are directed to systems and methods for assessing mergers and acquisition vulnerabilities in financial markets.

Embodiments allow advising institutions, such as financial institutions, to recognize times when a hostile party might take advantage of a market climate or other adverse events and attempt a hostile takeover. Embodiments may monitor public markets and may quantify the vulnerability of any given company based on publicly available data to protect the interests of these companies before other parties can exploit these vulnerabilities.

Embodiments may combine data with different dimensionalities and domains to create a complete view into the current state of a company. For example, embodiments may analyze available financial data and may benchmark a company's performance against a set of comparable companies from the industry. Next, embodiments may integrate governance and shareholder data and again benchmark against a smaller set of relevant comparable companies. Embodiments may explain the risk estimation of the models, and may generate a single score that correlates to a probability of a hostile mergers and acquisition transaction being initiated.

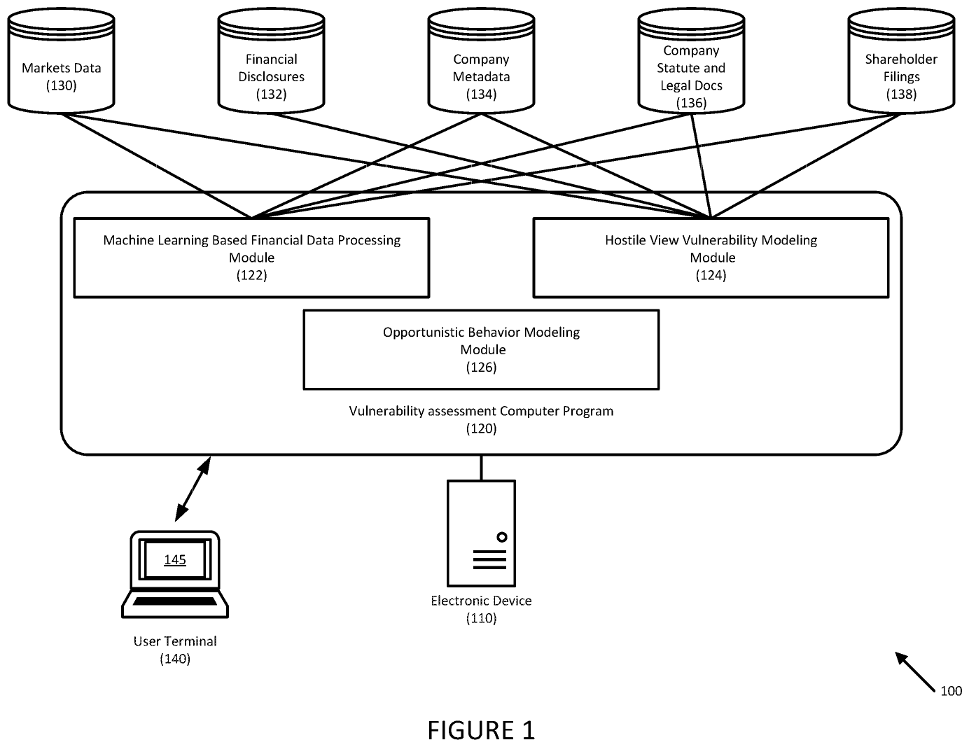

Referring to FIG. 1, a system for assessing mergers and acquisition vulnerabilities in financial markets is disclosed according to embodiments. System 100 may include electronic device 110 that may execute assessment computer program 120. Electronic device 110 may be any suitable electronic device, including servers (e.g., physical and/or cloud-based), computers (e.g., workstations, desktops, laptops, notebooks, tablets, etc.), smart devices, Internet of Things (IoT) devices, etc. Electronic device 110 may interface with external devices, including one or more user terminal 140. User terminal 140 may be any suitable electronic device, including computers (e.g., workstations, desktops, laptops, notebooks, tablets, etc.), smart devices, IoT devices, etc. User terminal 140 may execute vulnerability computer program 145, which may provide access to vulnerability assessment computer program 120 using a browser, a computer program or application, etc.

Vulnerability assessment computer program 120 may be a computer program that may include a plurality of modules, including machine learning based financial data processing module 122, hostile view vulnerability modeling module 124, and opportunistic behavior modelling module 126. Additional, other, or fewer modules may be provided as is necessary and/or desired.

System 100 may include a plurality of data sources, such as markets data 130, financial disclosure data 132, company metadata 134, company statute and legal document data 136, and shareholder filings data 138. Additional, different, or fewer data sources may be provided as is necessary and/or desired.

Markets data 130 may include stock prices for each company in scope, prices of holdings for each company in scope, trading volumes, etc.

Financial disclosure data 132 may include financial disclosures made by each company in scope, including government filings. Examples of such financial disclosures include SEC forms 10-K, 10-Q, 13-F, 8-K, proxy statements, etc.

Company metadata 134 may include information about the company, such as company age, size (e.g., number of employees, number of divisions, etc.), country, sector, industry, etc.

Company statute and legal document data 136 may include company documents of incorporation, a company statute and its revisions, published letters to shareholders, etc.

Shareholder filings data 138 may include any public filings by shareholders relative to one of the companies in scope. Examples include schedules 13-D and 13-G, SEC forms 3, 4, or 5, etc.

Although data 130, 132, 134, 136, and 138 may include public data, it should be recognized that private data for one or more company may be used as is necessary and/or desired.

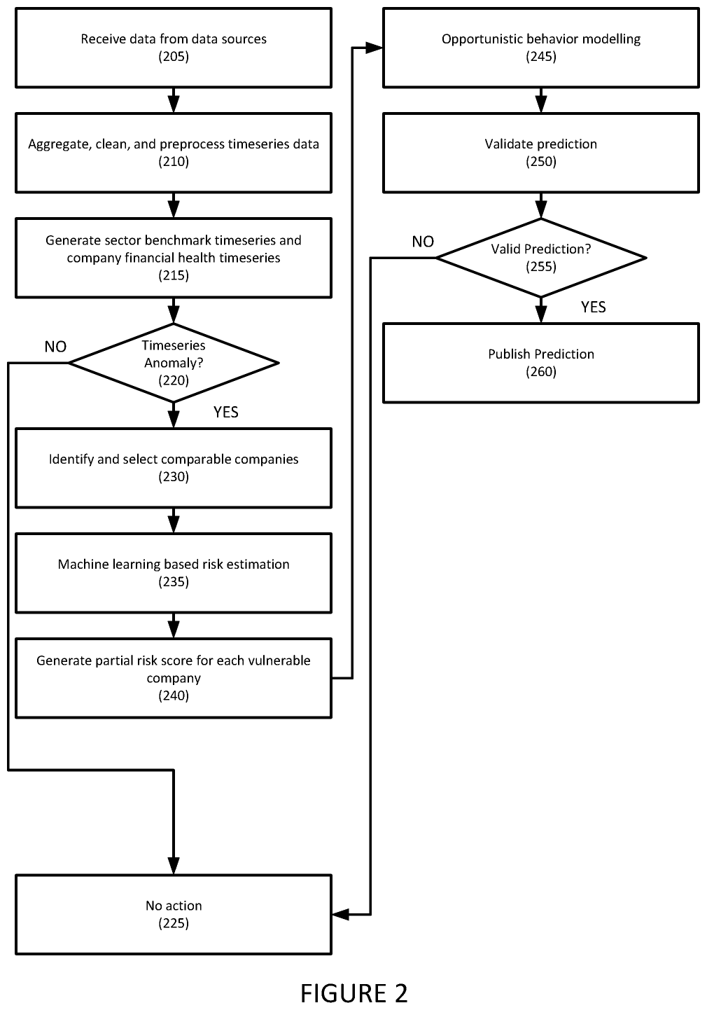

Referring to FIG. 2, a method for assessing mergers and acquisition vulnerabilities in financial markets is disclosed according to embodiments.

In step 205, a computer program, such as a vulnerability assessment computer program, may receive data, such as time series data, from a plurality of data sources for one or more companies in scope. In one embodiment, the data may include market data, financial disclosure data, company metadata, company statute and legal document data, and shareholder filings data. Additional, different, or other types of data may be provided as is necessary and/or desired.

In one embodiment, only data for companies in scope may be retrieved. For example, embodiments may limit the companies in scope to one or more client companies, one or more target company, companies with a specific NAICS (North American Industry Classification System) code, companies of a certain size, market cap, age, location, combinations thereof, etc.

In step 210, the vulnerability assessment computer program may aggregate, clean, and pre-process the data. For example, for daily time series data at the company level (e.g., share price, total shareholder return (TSR)), the data may be aggregated at the weekly level, and three time series data, such as minimum weekly value, average weekly value, and maximum weekly value, may be generated. In general, all available data is used unless there is less than a certain amount of data available (e.g., only nine months of data are available) for a company, if more than a certain amount (e.g., 50%) of data since the company's IPO is missing, or as otherwise necessary and/or desired.

Instead of using actual values, for certain periodic data, such as quarterly data (e.g., data extracted from financial disclosures), the data may be kept at each period, and the values may be normalized to their change period-over-period.

In one embodiment, data may be normalized at the company and industry level. When normalizing data at industry level, if the correlation among certain companies is above a certain amount (e.g., above 70%), only one “representative” time series out of the correlated ones may be kept.

In step 215, the vulnerability assessment computer program may generate sector benchmark time series data and company financial health time series data. In embodiments, these benchmarks may be generated using Dynamic Factor Models (DFM) with Principal Component Analysis (PCA) to estimate initial latent factors, and Kalman filters to expand the benchmarks over time. Both the company and industry time series are learned weighted indexes capturing the co-movements of the constituents.

Constituents for the company financial health time series may include share price performance, financial metrics extracted from SEC filings, per-share indicators, and/or other types of data may be provided as is necessary and/or desired. Constituents for the sector benchmark time series data may include share price performance for each company, macro market indicators, and other metrics specific to the sector in consideration.

In step 220, the vulnerability assessment computer program may determine if there is an anomaly in any of the components of the company financial health time series data that may indicate periods of financial underperformance. If there are no anomalies, in step 225, the process may stop.

In one embodiment, the identification of anomalies may involve a value, momentum, and volatility (VMV) comparison to the company financial health time series data. In a VMV comparison, embodiments may consider the rolling mean difference between each company and its industry, and may then evaluate the VMV for the rolling mean difference time series, including value (e.g., local minima over periods of, for example, 12 weeks), momentum (e.g., rolling aggregations over a period of time, such as a year, in agreement with the financial definition of momentum for time series across asset classes, and then identify companies who have broken the time series momentum principle (e.g., the last twelve months plus one was not correlated to the returns in the last month)), volatility (e.g., measure the volatility of the difference between time series), and trend decomposition (e.g., apply time series additive decomposition techniques to extract a time series trend for both the company and the industry benchmark, and then compare the trends; anytime the company trend has a negative slope versus a neutral/positive benchmark slope, the company may be flagged as a higher risk).

If there is an anomaly, in step 230, the vulnerability assessment computer program may identify and select comparable companies to the target company (i.e., the company with the anomaly). For example, the comparable companies may be in the same/similar industry as the target company, have a similar history of financial activities and events as the target company, and may be representative of trends in markets. Other similarities may be used to identify comparable companies as is necessary and/or desired.

In one embodiment, for the set of comparable companies, a company identifier, such as the NAICS designation that is one level above the target company, may be used for companies in the same industry. Public filings may then be used to build a history for the target company (with events such as equity or debt issuances, merger and acquisition transactions, etc.) to find companies with similar historical events at similar intervals in time as the target company. These comparable companies may be labeled for future reference.

Proxy time series data for the target company may be used to select a small subset of companies that have outperformed the industry in, that have been tracking the industry, and that have been underperforming the industry in, for example, the last twelve months. From each group, a certain number (e.g., five) of companies may be selected.

In addition, companies with similar historical events at similar intervals in time may be added if none were selected. A subset may be selected using the time series data generated in step 215, only keeping the best performing ones.

Company proxy filings may be used to add any self-reported comparables to this set. Depending on the number of self-reported comparables, embodiments may replace companies in the set in a round-robin manner. If the number of self-reported comparable companies in the set is below a certain number, they may be added.

In step 235, the vulnerability assessment computer program may perform machine learning-based risk estimation. In one embodiment, a machine learning model may be used to predict the probability of an adverse event. In one embodiment, the machine learning model may be periodically retrained (e.g., weekly) using a dataset composed of warnings that have been generated. This dataset may be augmented using occurrences of adverse events. Recent warnings, such as those within the past three months, may be excluded because they may be too recent to be labelled as true positives or false negatives.

For each warning, a curated set of features may be built, and the prediction may be based on this set of features. The curated set of features may include features from different domains, such as financial, trading, shareholder composition, governance structure, etc. For each target company, the comparable company set may be as a benchmark for the features, and the values may be compared to the median, mean, or a fixed threshold depending on the feature.

For model selection and hyperparameter optimization, embodiments may perform a standard grid search and may select the model with the highest F1-score.

In addition, Shapley Additive Explanations (SHAP) may be used to identify a feature importance or feature weighting for each feature in the prediction. The feature weightings represent the contribution of each feature going into the prediction to the final prediction.

In step 240, the vulnerability assessment computer program may generate a partial risk score for each vulnerable company. Embodiments may combine the several artifacts that the models have produced so far to build a single score (e.g., from 1 to 10, with 10 being highest danger; red-amber-green, letter scale, etc.) for the warning in consideration. The components of this final score may include the prediction from the risk estimation model, the feature importance for each prediction, and quantitative indicators derived from the time series data benchmarking and anomaly detection; such indicators may include a percentage difference of their growth rate, the slope of the linear trend or the difference in volatility. In one embodiment, these components may be combined in a weighted average, with the weights being periodically optimized such that the distribution of the final score behaves as close as possible to the following “golden standard”: warning scores should be normally distributed around the mid-point (e.g., 5); warnings generated closer to an adverse event should have a higher warning score, and earlier warnings should have a lower score; and warnings scores above a certain value (e.g., 7) may have a certain precision (e.g., a percent of warnings with an event announced within a certain period of time months) of at least, for example, 30%.

In step 245, the vulnerability assessment computer program may perform opportunistic behavior modelling. For example, a machine learning model may be used to evaluate a potentially aggressive investor appetite for a transaction based on the investor's recent history, including its activities (e.g., M&A activities). This process may involve pulling data for other investors active in the same sector or industry.

In step 250, the vulnerability assessment computer program may validate its prediction. In one embodiment, a machine learning model may look at historical predictions from the model that turned into positive samples and compare those historical predictions with the current pool of predictions. If, in step 255, the prediction is valid, in step 260, the vulnerability assessment computer program may publish the prediction. The published prediction may include the list of comparables from step 230, the risk score from step 235, SHAP weightings from step 235 and the probability estimation from step 245.

The prediction may be published, for example, to a web application, and notifications based on the prediction may be provided to interested parties, such as client executives, coverage bankers, etc. If the prediction is not valid, in step 225, the process may stop.

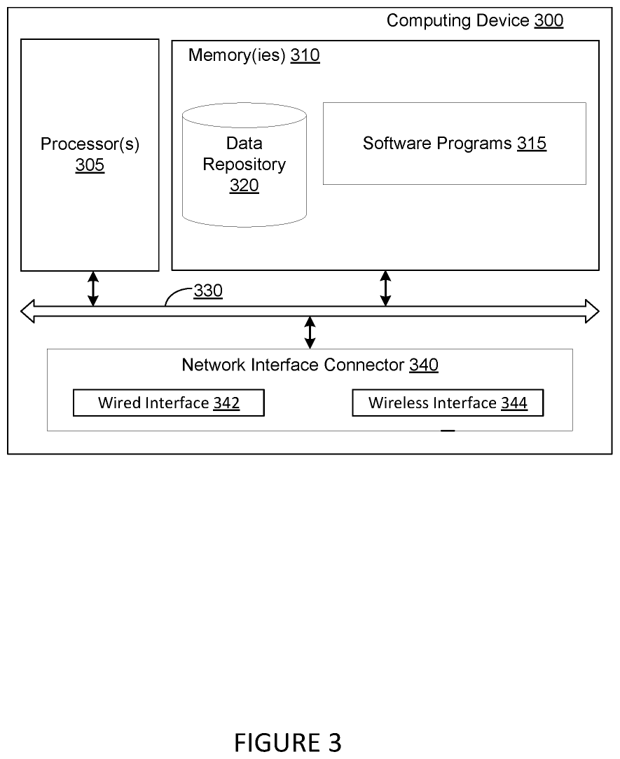

FIG. 3 depicts an example of a computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for assessing company vulnerabilities in financial markets, comprising:
receiving, by vulnerability assessment computer program, time series data for a plurality of companies;
aggregating, cleaning, and pre-processing, by the vulnerability assessment computer program, the time series data for each company;
generating, by the vulnerability assessment computer program, sector benchmark data for each company comprising a sector value benchmark, a sector momentum benchmark, and a sector volatility benchmark;
generating, by the vulnerability assessment computer program, company financial health time series data for each company comprising company share price performance, company financial metrics extracted from SEC filings, and/or per-share indicators;
identifying, by the vulnerability assessment computer program, an anomaly in the financial health time series data for one of the companies, wherein the anomaly is identified comparing a value, a momentum, and a volatility for each company to the sector value benchmark, the sector momentum benchmark, and the sector volatility benchmark, respectively;
identifying, by the vulnerability assessment computer program, a plurality of comparable companies to the one company;
predicting, by the vulnerability assessment computer program using a trained machine learning-based risk estimation engine, a probability of an adverse event for the one company based on a plurality of features;
generating, by the vulnerability assessment computer program, a partial risk score for the one company comprising the probability of the adverse event, quantitative indicators derived from the time series data benchmarking and anomaly detection, and a feature weighting for each of the plurality of features;
validating, by the vulnerability assessment computer program, the prediction; and
publishing, by the vulnerability assessment computer program, the prediction.

2. The method of claim 1, further comprising:
normalizing the time series data at an industry level.

3. The method of claim 1, wherein the benchmarks are generated using dynamic factor models with principal component analysis.

4. The method of claim 1, wherein the time series data comprises a learned weighted index capturing co-movements of its constituents.

5. The method of claim 1, wherein the sector benchmark time series data for each company comprises share price performance for each company and/or macro market indicators.

6. The method of claim 1, wherein the plurality of comparable companies to the one company are identified using a North American Industry Classification System (NAICS) designation and public filings for the comparable companies.

7. The method of claim 1, wherein the plurality of features comprise financial features, trading features shareholder composition features, and governance structure features.

8. A system, comprising:
a plurality of data sources comprising a markets data data source, a financial disclosure data source, a company metadata data source, a company statute and legal documents data source, and a shareholder filings data source; and
a vulnerability assessment computer program executed by an electronic device;
wherein:
the vulnerability assessment computer program receives time series data for a plurality of companies from the plurality of data sources;
the vulnerability assessment computer program aggregates, cleans, and pre-processes the time series data for each company;
the vulnerability assessment computer program generates sector benchmark data for each company comprising a sector value benchmark, a sector momentum benchmark, and a sector volatility benchmark;
the vulnerability assessment computer program generates company financial health time series data for each company comprising company share price performance, company financial metrics extracted from SEC filings, and/or per-share indicators;
the vulnerability assessment computer program identifies an anomaly in the financial health time series data for one of the companies, wherein the anomaly is identified comparing a value, a momentum, and a volatility for each company to the sector value benchmark, the sector momentum benchmark, and the sector volatility benchmark, respectively;
the vulnerability assessment computer program identifies a plurality of comparable companies to the one company;
the vulnerability assessment computer program predicts, using a trained machine learning-based risk estimation engine, a probability of an adverse event for the one company based on a plurality of features;
the vulnerability assessment computer program generates a partial risk score for the one company comprising the probability of the adverse event, quantitative indicators derived from the time series data benchmarking and anomaly detection, and a feature weighting for each of the plurality of features;
the vulnerability assessment computer program validates the prediction; and
the vulnerability assessment computer program publishes the prediction.

9. The system of claim 8, wherein the vulnerability assessment computer program normalizes the time series data at an industry level.

10. The system of claim 8, wherein the benchmarks are generated using dynamic factor models with principal component analysis.

11. The system of claim 8, wherein the time series data comprises a learned weighted index capturing co-movements of its constituents.

12. The system of claim 8, wherein the sector benchmark time series data for each company comprises share price performance for each company and/or macro market indicators.

13. The system of claim 8, wherein the plurality of comparable companies to the one company are identified using a North American Industry Classification System (NAICS) designation and public filings for the comparable companies.

14. The system of claim 8, wherein the plurality of features comprise financial features, trading features shareholder composition features, and governance structure features.

15. A non-transitory computer readable storage medium, including instructions stored thereon, which when read and executed by one or more computer processors, cause the one or more computer processors to perform steps comprising:
receiving time series data for a plurality of companies;
aggregating, cleaning, and pre-processing the time series data for each company;
generating sector benchmark data for each company comprising a sector value benchmark, a sector momentum benchmark, and a sector volatility benchmark;
generating company financial health time series data for each company comprising company share price performance, company financial metrics extracted from SEC filings, and/or per-share indicators;
identifying an anomaly in the financial health time series data for one of the companies, wherein the anomaly is identified comparing a value, a momentum, and a volatility for each company to the sector value benchmark, the sector momentum benchmark, and the sector volatility benchmark, respectively;
identifying a plurality of comparable companies to the one company;
predicting, using a trained machine learning-based risk estimation engine, a probability of an adverse event for the one company based on a plurality of features;
generating a partial risk score for the one company comprising the probability of the adverse event, quantitative indicators derived from the time series data benchmarking and anomaly detection, and a feature weighting for each of the plurality of features;
validating the prediction; and
publishing the prediction.

16. The non-transitory computer readable storage medium of claim 15, further including instructions stored thereon, which when read and executed by one or more computer processors, cause the one or more computer processors to perform steps comprising normalizing the time series data at an industry level.

17. The non-transitory computer readable storage medium of claim 15, wherein the time series data comprises a learned weighted index capturing co-movements of its constituents.

18. The non-transitory computer readable storage medium of claim 15, wherein the sector benchmark time series data for each company comprises share price performance for each company and/or macro market indicators.

19. The non-transitory computer readable storage medium of claim 15, wherein the plurality of comparable companies to the one company are identified using a North American Industry Classification System (NAICS) designation and public filings for the comparable companies.

20. The non-transitory computer readable storage medium of claim 15, wherein the plurality of features comprise financial features, trading features shareholder composition features, and governance structure features.
